(19) United States
(12) Patent Application Publication
(10) Pub. No.: US 2009/0022441 A1
(43) Pub. Date: Jan. 22, 2009

(54) Assembly Forming a Bearing Housing Equipped with an Information Sensing System

(75) Inventors: Julien Berthier, Saint Jorioz (FR); Siegfried Ruhland, Saint Sylvestre (FR)

Correspondence Address: BACHMAN & LAPOINTE, P.C., 900 CHAPEL STREET, SUITE 1201, NEW HAVEN, CT, 06510, US

(73) Assignee: SNR ROULEMENTS, Annecy (FR)

(21) Appl. No.: 12/175,687

(22) Filed: Jul. 18, 2008

(30) Foreign Application Priority Data
Jul. 20, 2007 (FR) FR 07 05 303

(51) Int. Cl. F16C 32/04

(52) U.S. Cl. 384/448

(57) ABSTRACT

An assembly forming a bearing housing is equipped with an information sensing system comprising a coder generating magnetic pulses and a sensor provided with at least two sensitive elements able to detect these pulses. The bearing has a rotating internal member, a fixed external member and rolling bodies disposed in a bearing space. The bearing housing also has a cover secured to the fixed member in order to obstruct the bearing space laterally. The coder is secured to the rotating member behind the cover and the sensitive elements being disposed opposite the coder, in front of the cover, so that the pulses are detected through the cover. The sensor has a device for processing the signals detected by the sensitive elements. The device comprises a triggering device and a device for applying the XOR function to the signals triggered, so as to increase the resolution of the output signal with respect to that of the signals detected.

### BACKGROUND

The invention concerns an assembly forming a bearing housing equipped with an information sensing system comprising a coder generating magnetic pulses and a sensor provided with at least two sensitive elements able to detect these pulses.

Such assemblies, when they are equipped with a system sensing rotation speed, angular position and/or direction of rotation, can in particular be employed for mounting a motor vehicle wheel that is provided with an anti-lock system for said wheel. This is because the information can then be used by a braking assistance computer.

One of the problems that is posed with such an assembly is the protection of the bearing space vis a vis pollution from the surrounding environment, and in particular the protection of the coder disposed in the vicinity of said space.

To resolve this problem, it has been proposed to attach a cover to the bearing housing in order to protect the coder. However, in cases where the sensor is disposed in front of the cover, the problem is then posed of reading the magnetic pulses through said cover. This is because the sensitive elements must be disposed at an air-gap distance from the coder in order to be able to read the information and, apart from the distancing inherent in the presence of the cover, passing through the latter also attenuates the amplitude of the information to be read.

In addition, this problem is all the more critical in the case of an assembly forming a bearing housing for mounting a non-driving wheel of the motor vehicle. This is because in this case the rotating member carrying the coder is the internal member, which therefore has a smaller diameter compared with a rotating member including a transmission. The result is therefore that the diameter of the coder is also small, which limits the size of the magnetic poles generating the pulses, and therefore the amplitude of said pulses. Consequently, in particular in this type of mounting, the air-gap distance is too small to be able to equip the bearing housing with a cover protecting the coder.

To resolve this problem, it has been proposed to equip the bearing housing with a cover integrating the sensor on its face opposite the sensitive elements. Though this solution makes it possible to surmount the limitation of the air-gap distance by moving the sensor closer to the sensitive elements, it makes more complex the design of a sensor cover, which is specific for each mounting geometry.

### SUMMARY OF THE INVENTION

The aim of the invention is to mitigate the problems of the prior art by proposing an assembly forming a bearing housing in which the coder is protected by a cover while maintaining the resolution of the information delivered through said cover, and this even for small coder diameters and/or sensors mechanically separate from the bearing housing.

To this end, the invention proposes an assembly forming a bearing housing equipped with an information sensor system comprising a coder generating magnetic pulses and a sensor provided with at least two sensitive elements able to detect these pulses, said bearing comprising a rotating internal member, a fixed external member and rolling bodies disposed in a bearing space formed between said members to allow their relative rotation, said bearing housing also comprising a cover secured to the fixed member in order to obstruct said bearing space laterally, in which:
said coder is secured to the rotating member behind said cover and the sensitive elements being disposed, opposite said coder, in front of said cover so that the pulses are detected through said cover; and
the sensor comprises a device for processing the signals detected by the sensitive elements, said device comprising triggering means and means of applying the XOR (exclusive OR) function to the signals triggered, so as to increase the resolution of the output signal with respect to that of the detected signals.

### BRIEF DESCRIPTION OF THE DRAWINGS

Other objects and advantages of the invention will emerge from the following description, given with reference to the accompanying figures, in which:

FIG. 1 depicts in longitudinal section an assembly forming a bearing housing according to an embodiment of the invention;

FIG. 2 is an enlarged view of FIG. 1 showing the respective arrangements of the coder, the cover and the sensor with respect to the bearing housing;

FIG. 3 is a diagram presenting the processing of the signals detected.

### DETAILED DESCRIPTION OF THE PREFERRED EMBODIMENT(S)

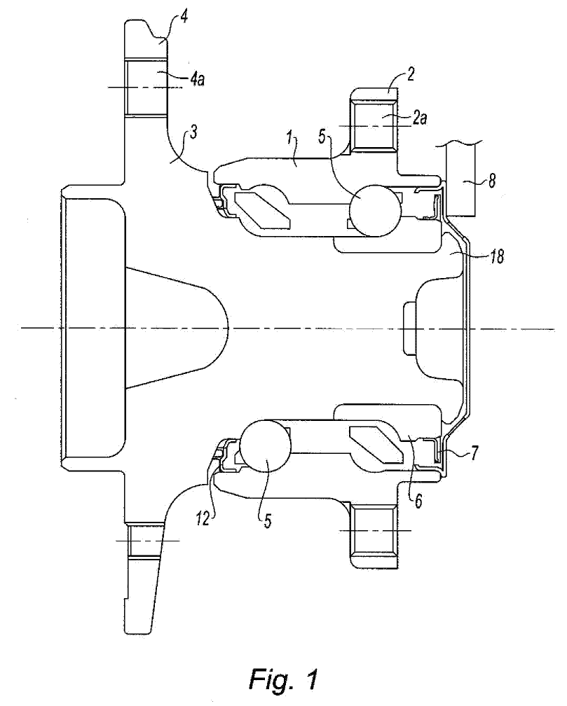

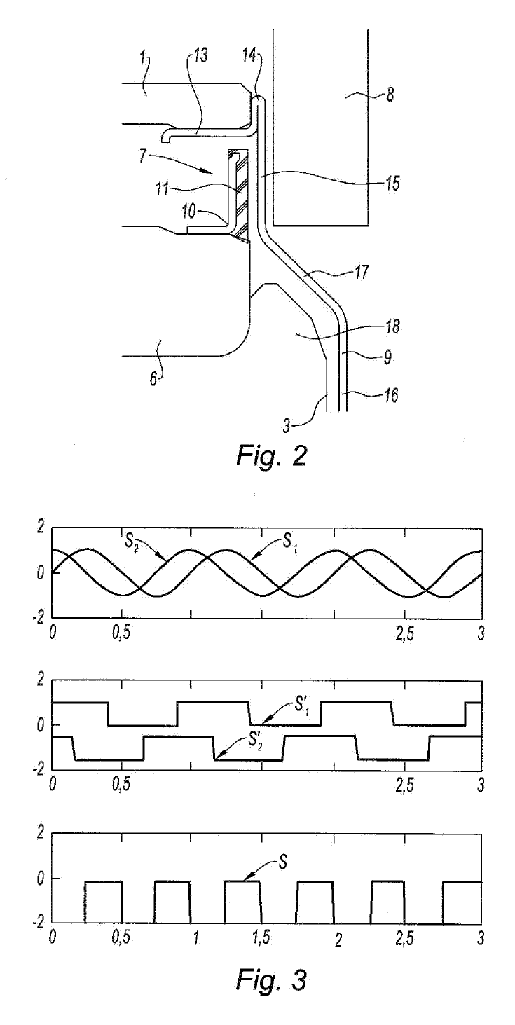

In relation to FIGS. 1 and 2, an embodiment of an assembly forming a bearing housing is described below, in particular for mounting a non-driving wheel of a motor vehicle.

The bearing housing comprises a fixed external member 1 comprising a flange 2 provided with fixing holes 2a arranged to allow the fixing of the bearing housing by screwing or bolting, for example to a suspension element of the motor vehicle. The bearing housing also comprises a rotating internal member 3 that is provided with a plate 4 provided with fixing holes 4a to allow the association of the wheel.

Between these two members 1, 3, a bearing space is formed to allow the relative rotation of the said members. To do this, each member 1, 3 has two bearing tracks spaced apart axially, so as to form between the said members two bearing ways in which there is disposed respectively a row of rolling bodies 5 in the form of balls.

In FIG. 1, the internal member 3 comprises a body and an attached ring 6 that is fitted on the external surface of the said body, a bearing track being produced on the said ring and the other bearing track being produced on the body. However, the invention is not limited to this embodiment of the bearing housing, in particular in relation to the presence of the flange and the plate, the design of the bearing way, the geometry of the rolling bodies and the geometries of the fixed and rotating members.

When it is wished to know the rotation speed, the direction of movement and/or the angular position of the rotating member 3 with respect to the fixed member 1, it is known how to use an information sensor system comprising, secured to the rotating member, a coder 7 generating magnetic pulses and a fixed sensor 8 provided with at least two sensitive elements able to detect these pulses.

In order to protect the coder 7 from pollution from the surrounding environment, the bearing housing also comprises a cover 9, for example metal, which is secured to the fixed member 1 in order to obstruct the bearing space laterally. To do this, the coder 7 is secured to the rotating member 3 behind the cover 9 and the sensitive elements are disposed, opposite said coder, in front of the cover 9 so that the pulses are detected through the said cover.

In the embodiment depicted, the coder 7 comprises a frame 10, for example produced from pressed sheet metal, which comprises an axial surface for fitting on the outside diameter of a surface of the rotating ring 6, and a radial surface on which the magnetic pulse generating means is secured.

In an example embodiment, the generating means is formed by a multi-pole magnet 11 made from synthetic material, which is moulded onto the radial surface, the said material containing magnetic particles so as to form a plurality of contiguous poles with a magnetisation direction reversed from one pole with respect to the two contiguous poles.

The coder 7 is secured to the internal member 3 on one side of the bearing space, more precisely on the side opposite to the wheel fixing flange 4. In addition, the other side of the bearing space is sealed by arranging a seal 12 with rubbing lips.

In the embodiment depicted, the cover 9 comprises a solid disc that is provided with an edge on which an axial surface 13 is formed, said surface being fitted on the inside diameter of a corresponding surface on the external member 1. In addition, the axial surface 13 is connected to the disc by means of a radial fold 14 that is disposed in abutment on a radial end surface of the external member.

In this embodiment, in particular by providing for the coder 7 to be disposed substantially radially in line with the end surface (see FIG. 2), the axial positioning of the cover 9 is well defined relative to the axial position of the multi-pole magnet 11. Thus the axial clearance between the coder 7 and the cover 9 can be minimised so as to limit the distance between the coder 7 and the sensitive elements.

Still in order to limit the distance between the coder 7 and the sensitive elements, the disc has a lateral portion 15 radially in line with the fold 14, said portion being intended to be interposed between the coder 7 and the sensor 8. The disc also has a central geometry that is adapted to cover the end of the rotating member 3 without interference. More precisely, the disc has a central portion 16 offset axially with respect to the lateral portion 15, the said portion being connected by a connecting fillet 17 so as to overlap the annular fold 18 formed on the end of the body of the rotating member 3 in order to hold the ring 6 axially.

In the embodiment shown, the sensor 8 is mechanically separate from the fixed member 1 and the cover 9, in particular by disposing the sensitive elements opposite the lateral portion 15 with a clearance between them.

In addition to the limitation of the reading distance by disposing the sensitive elements as close as possible relative to the coder 7, the invention provides an information sensing system in which the coder 7 emits a signal of high amplitude relative to its size and the sensor 8 delivers a signal whose resolution is adapted to the application envisaged.

To do this, the multi-pole magnet 11 comprises a small number of pairs of poles, for example 2N pairs of poles with N strictly less than 24. In particular, N may be equal to 12 or 6 so as to have a multi-pole magnet with 24 or 12 pairs of poles. Thus, the number of pairs of poles being small, their size is greater so that each pole delivers a signal of greater amplitude. The result is therefore that the air-gap distance, that is to say the distance at which the sensitive elements can detect the signal delivered, is greater than with a conventional magnet with 48 pairs of poles for example.

However, the resolution of the signal delivered by such a magnet 11 is less great, since the number of pulses per turn of the coder 7 depends directly on the number of pairs of poles.

In order to get rid of this drop in resolution, the sensor 8 comprises a device for processing the signals detected by the sensitive elements that is arranged to increase the resolution of the output signal with respect of that of the signals detected. To do this, the processing device comprises triggering means and means of applying the XOR (exclusive OR) function on the signals triggered.

In relation to FIG. 3, the processing of two sinusoidal analogue signals S1, S2 that are delivered by the sensitive elements is described. In this embodiment, the sensitive elements can comprise a Hall effect sensors or magnetoresistors. In particular, two sensitive elements can be used in order each to deliver a sinusoidal signal S1, S2, or two groups of sensitive elements can be used in order, by adding each of the signals of a group, to deliver the two sinusoidal signals S1, S2 issuing respectively from a group. In the remainder of the description, the term “sensitive element” is used to designate indifferently either a sensitive element or a group of sensitive elements.

In FIG. 3, the two sinusoidal signals S1, S2 are in quadrature and have a resolution equal to that of the signal delivered by the magnet 11. According to one embodiment, this quadrature can be obtained by disposing the two sensitive elements at a distance equal to a half pole length of the magnet 11.

According to another embodiment, when the distance between sensitive elements is not perfectly adapted to the pole length of the magnet 11, the processing device also comprises means of combining the two sinusoidal signals issuing respectively from a sensitive element, so as to deliver two signals S1, S2 in quadrature. In particular, the combination means can form the sum and the difference of the signals so as to deliver respectively the signals S1, S2 in quadrature.

Next, the signals S1, S2 in quadrature are processed by the triggering means in order to form the digital signals S′1 and S′2. To do this, the signals S1, S2 can be triggered around zero in a triggering circuit in which the amplitude of the output signal has an abrupt and large variation in amplitude for a small increase in the input signal from a zero value, so as to form the square signals S′1, S′2 as shown in FIG. 3. The digital signals S′1, S′2 are offset in phase by 90° electrical and have a resolution equal to that of the multi-pole magnet 11.

In the embodiment shown, the resolution of the signals S′1, S′2 is then multiplied by 2 by applying the XOR function. Thus, in the case of a coder with 24 pairs of poles, the resolution of the output signal S is equivalent to that of a coder with 48 pairs of poles.

1-8. (canceled)

9. Assembly forming a bearing housing equipped with an information sensing system comprising a coder generating magnetic pulses and a sensor provided with at least two sensitive elements able to detect said pulses, a bearing comprising a rotating internal member, a fixed external member, and rolling bodies disposed in a bearing space formed between said members to allow relative rotation, said bearing further comprising a cover secured to the fixed external member in order to obstruct said bearing space laterally;
said coder being secured to the rotating member behind said cover and the sensitive elements being disposed, opposite said coder, in front of said cover, so that the pulses are detected through said cover; and
the sensor comprising a device for processing the signals detected by the sensitive elements, said processing device comprising means for triggering signals and means for applying an XOR function to the signals triggered, so as to increase the resolution of an output signal with respect to that of detected signals.

10. Assembly according to claim 9, wherein the coder comprises a multi-pole magnet comprising 2N pairs of poles, with N being less than 24.

11. Assembly according to claim 10, wherein N is equal to 12 or 6.

12. Assembly according to claim 9, wherein the sensitive elements deliver two sinusoidal signals.

13. Assembly according to claim 12, wherein the processing device further comprises means for combining two sinusoidal signals so as to deliver two sinusoidal signals in quadrature, and the signals in quadrature are processed by the triggering means and by the XOR function.

14. Assembly according to claim 9, wherein the sensor is separate mechanically from the fixed member and from the cover.

15. Assembly according to claim 9, wherein an edge of the cover comprises an axial surface that is fitted on an inside diameter of a corresponding surface on the external member.

16. Assembly according to claim 15, wherein the axial surface is connected to the cover by a radial fold that is disposed in abutment on a radial surface of the external member.
